(19) United States
(12) Patent Application Publication
(10) Pub. No.: US 2003/0127469 A1
(43) Pub. Date: Jul. 10, 2003

(54) Flow control and storage funnel

(76) Inventor: Bruce Terry, Atlanta, GA (US)

Correspondence Address: Wheeler Law Offices, P.C., P.O. Box 22035, Pittsburgh, PA, 15222, US

(21) Appl. No.: 10/038,549

(22) Filed: Jan. 4, 2002

(51) Int. Cl. B67D 5/38

(52) U.S. Cl. 222/158; 222/460; 222/556

(57) ABSTRACT

A flow control and storage funnel is disclosed herein. The preferred embodiment of said flow control and storage funnel has a top cap and a bottom cap allowing storage of substances therewithin. It further has built in flow control valve, volumetrically scaled increments noted on the body thereof and a gooseneck attachment for the transfer of substances into hard to reach places.

### FIELD OF THE INVENTION

The present invention relates generally to funnels. More specifically, the present invention relates to a funnel device that is devised to control flow and store substances therewithin.

### BACKGROUND OF THE INVENTION

There are many different types and styles of funnels that are readily available in the current marketplace. Use of such funnels, however, requires that the user carefully gauge the amount of substance that he or she is pouring into the funnel. If the container or chamber that is being filled fills up before all of the substance within the funnel is used, the user has a difficult and messy situation trying to get the unused portion of the substance back into its original container. Consequently, the need exists for a funnel that can store remaining substance and does not need to be emptied. The present invention fulfills this need.

Further, when one is pouring substance into a container or chamber through a conventional funnel and said container or chamber is getting near to being full, there is no way for the user to control the speed at which the substance already in the funnel enter the container or chamber. Consequently, the need exists for a funnel that is adapted to control the speed at which substance flows therethrough. The present invention fulfills this need.

### SUMMARY OF THE INVENTION

The present invention, the flow control and storage funnel, is shaped much like a conventional funnel. The flow control and storage funnel has caps to cover its top and bottom openings that seal the funnel and create a storage unit for substances. Further, in the preferred embodiment, the flow control and storage funnel has a valve system that allows the user to control the speed at which the substance is allowed to flow through the funnel. The preferred embodiment also has volumetric increments noted along an outer side of the flow control and storage funnel that allows the user to gauge how much substance has been added and how much more is needed or is left over, etc. Lastly, the preferred embodiment has a gooseneck attachment allowing the user to pour substance through the flow control and storage funnel into hard to reach areas.

It is an object of the present invention to provide a device that acts as a conventional funnel and can conveniently store substances.

It is a further object of the present invention to provide a device that can be used to pour substances into small openings without extraneous mess.

It is another object of the present invention to provide a device that allows the user to determine how much of the substance has been used and/or how much is left.

It is yet another object of the present invention to provide a device that can be used to pour substances into small openings in hard to reach areas without extraneous mess.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the preferred embodiment of the flow control and storage funnel.

FIG. 2 is a perspective view of an alternative embodiment of the flow control and storage funnel.

FIG. 3 is a front view of the flow control and storage funnel in use.

FIG. 4 is a perspective view of the gooseneck attachment of the flow control and storage funnel.

### DETAILED DESCRIPTION OF THE INVENTION

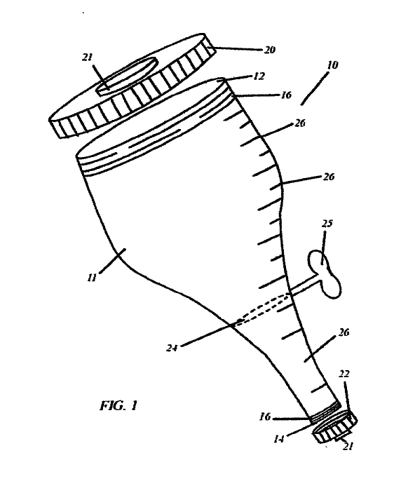

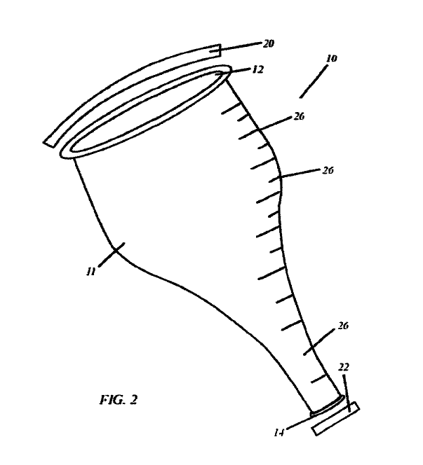

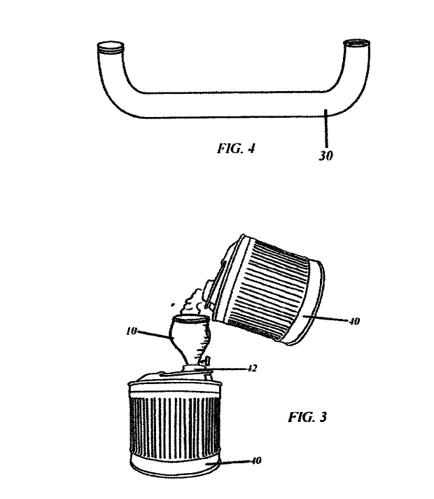

The preferred embodiment of the flow control and storage funnel 10 can be seen in FIG. 1. As can be seen, the flow control and storage funnel 10 has the same basic shape as a conventional funnel. One of ordinary skill in the art would readily recognize that the overall shape of the funnel body 11 of the flow control and storage funnel 10 can be changed without altering the function of the flow control and storage funnel 10 as long as the top opening 12 remains wider than the bottom opening 14 with the bottom opening 14 able to fit within the fill ports 42 of containers, chambers, etc. 40 as desired. See FIG. 3. It is preferred that the funnel body 11 of the flow control and storage funnel 10 is constructed from plastic although one of ordinary skill in the art would readily recognize that other materials, including but not limited to, metal, can be used to construct the funnel body 11. The preferred embodiment of the flow control and storage funnel 10 has ridges 16 along the outer perimeter of the top opening 12 of the funnel body 11 and also along the outer perimeter of the bottom opening 14 of the funnel body 11. These ridges 16 matingly engage with ridges (not shown) along the inner perimeter of the top cap 20 and the bottom cap 22, respectively. Both the top cap 20 and the bottom cap 22 also have gaskets along the inner perimeter of each to prevent liquid seepage and leaks. One of ordinary skill in the art would readily recognize, however, that the caps 20, 22 need not have gaskets, and that the caps 20, 22 can fasten to the funnel body 11 by snapping thereon instead of being screwed thereon. If the flow control and storage funnel 10 is used to transfer a powder substance, gaskets and screw on caps are not necessary. Snap-on caps are sufficient in such an instance. See FIG. 2. It is preferred that each cap 20, 22 have a small handle 21 thereupon for ease of applying and removing said caps 20, 22. Said handle 21 is not necessary, however.

The preferred embodiment of the flow control and storage funnel 10 also has an on/off flow control valve 24 that is used to adjust the rate of flow of a substance through the funnel body 11. It is preferred that the flow control valve 24 be easily operable by a key-like mechanism 25 located on the outside of the funnel body 11 such that the flow of the substance within the funnel body 11 is controlled by turning the key-like mechanism 25. As the key-like mechanism 25 is turned, the flow control valve 24 within the funnel body 11 is moved therewith to adjust the rate of flow of the substance that is being transferred.

In the preferred embodiment of the flow control and storage funnel 10, volumetrically scaled increments 26 are printed, pressed, etc. onto the outside of the funnel body 11 allowing the user to note how much of the substance being transferred has been used and/or how much of said substance is left after the container or chamber, etc. 40 that is being filled is full.

As seen in FIG. 4, the preferred embodiment of the flow control and storage funnel 10 has a gooseneck attachment 30 that can be fastened onto the bottom opening 14 of the funnel body 11. The gooseneck attachment 30 is preferably made of a flexible plastic. One of ordinary skill in the art would readily recognize, however, that the gooseneck attachment 30 can be constructed from a number of materials, including, but not limited to, a pliable metal. It is further preferred that the gooseneck attachment 30 is tube-like in nature. The gooseneck attachment 30 is used to transfer substances into hard to reach places, such as, but not limited to, filling windshield washer fluid on some automobiles. In the preferred embodiment, when not in use, one end of the gooseneck attachment 30 is capable of fastening to the other end of the gooseneck attachment 30 such that it forms a ring for easy storage.

Although this invention has certain preferred embodiments, it will be obvious to those skilled in the art that various changes and modifications may be made therein without departing from the invention, and all such changes and modifications are intended to fall within the true spirit and scope of the invention.

What is claimed is:

1. A flow control funnel comprising:
a funnel said funnel having a hollow body, a first open end and a second open end, the first open end larger than the second open end;
a regulating valve incorporated within the stem of the funnel, said regulating valve having an external means for adjusting the regulation of and otherwise stopping the flow of materials through the funnel such that when said means for adjusting is rotated, the regulation valve within the stem of the funnel is correspondingly rotated.

2. The flow control funnel of claim one further comprising volumetrically scaled increments noted on the exterior body of the funnel.

3. The flow control funnel of claim one further comprising a gooseneck adaptor removably attached to the second open end of the funnel.

4. A flow control and storage funnel comprising:
a funnel, said funnel having a hollow body, a first open end and a second open end, the first open end larger than the second open end, and means for receiving screw-on covers along the outer periphery of both the first and the second open ends thereof;
a first screw-on cover, said first screw-on cover sized to fit over the first end of the funnel, said first screw-on cover having sides that partially overlap the sides of the funnel said first screw-on cover having threads along the inner periphery of the sides of the cover such that said threads matingly engage with the means for receiving screw-on covers along the outer periphery of the first open end of the funnel, said first screw-on cover having a gasket therein to prevent leakage of material within the funnel when tightly secured to the funnel; and,
a second screw-on cover, said second screw-on cover sized to fit over the second end of the funnel, said second screw-on cover having sides that partially overlap the sides of the funnel, said second screw-on cover having threads along the inner periphery of the sides of the cover such that said threads matingly engage with the means for receiving screw-on covers along the outer periphery of the second open end of the funnel, said second screw-on cover having a gasket therein to prevent leakage of material within the funnel when tightly secured to the funnel.

5. The flow control and storage funnel of claim four further comprising a regulating valve incorporated within the stem of the funnel, said regulating valve having an external means for adjusting the regulation of and otherwise stopping the flow of materials through the funnel such that when said means for adjusting is rotated, the regulation valve within the stem of the funnel is correspondingly rotated.

6. The flow control funnel of claim four further comprising volumetrically scaled increments noted on the exterior body of the funnel.

7. The flow control funnel of claim four further comprising a gooseneck adaptor removably attached to the second open end of the funnel.

8. A flow control and storage funnel comprising:
a funnel, said funnel having a hollow body, a first open end and a second open end, the first open end larger than the second open end, and means for receiving snap-on covers along the outer periphery of both the first and the second open ends thereof;
a first snap-on cover, said first snap-on cover sized to fit over the first end of the funnel, said first snap-on cover having sides that partially overlap the sides of the funnel, said first snap-on cover having a gasket therein to prevent leakage of material within the funnel when tightly secured to the funnel; and,
a second snap-on cover, said second snap-on cover sized to fit over the second end of the funnel, said second snap-on cover having sides that partially overlap the sides of the funnel, said second snap-on cover having a gasket therein to prevent leakage of material within the funnel when tightly secured to the funnel.

9. The flow control and storage funnel of claim eight further comprising a regulating valve incorporated within the stem of the funnel, said regulating valve having an external means for adjusting the regulation of and otherwise stopping the flow of materials through the funnel such that when said means for adjusting is rotated, the regulation valve within the stem of the funnel is correspondingly rotated.

10. The flow control funnel of claim eight further comprising volumetrically scaled increments noted on the exterior body of the funnel.

11. The flow control funnel of claim eight further comprising a gooseneck adaptor removably attached to the second open end of the funnel.
